(19) United States
(12) Patent Application Publication
(10) Pub. No.: US 2025/0047356 A1
(43) Pub. Date: Feb. 6, 2025

(54) METHOD AND APPARATUS FOR BEAM FAILURE RECOVERY OF SECONDARY CELL

(71) Applicant: FUJITSU LIMITED, Kawasaki-shi, Kanagawa (JP)

(72) Inventors: Meiyi JIA, Beijing (CN); Lei ZHANG, Beijing (CN); Xin WANG, Beijing (CN)

(73) Assignee: FUJITSU LIMITED, Kawasaki-shi, Kanagawa (JP)

(21) Appl. No.: 18/922,863

(22) Filed: Oct. 22, 2024

Related U.S. Application Data
(63) Continuation of application No. PCT/CN2022/088854, filed on Apr. 24, 2022.

(51) Int. Cl. H04B 7/06; H04L 1/1812; H04W 72/231

(52) U.S. Cl. CPC H04B 7/06964; H04L 1/1812; H04W 72/231

(57) ABSTRACT

An apparatus for beam failure recovery of a secondary cell includes: a transmitter configured to transmit a first MAC (Medium Access Control) CE (Control Element) containing beam failure information of the secondary cell, the first MAC CE including a MAC CE containing BFD (Beam Failure Detection)-RS (Reference Signal) set information, the MAC CE containing BFD-RS set information including at least one of the following: an enhanced BFR (Beam Failure Recovery) MAC CE, and a truncated enhanced BFR MAC CE; and processor circuitry configured to, when the first MAC CE containing beam failure information of the secondary cell is transmitted or is successfully transmitted, enable a MAC entity of a terminal equipment to perform one of the following or a combination thereof: cancelling all triggered BFRs of the secondary cell; resetting a beam failure instance counter; considering a beam failure recovery procedure completed successfully.

### CROSS-REFERENCE TO RELATED APPLICATION

This application is a continuation application of International Application PCT/CN2022/088854 filed on Apr. 24, 2022, and designated the U.S., the entire contents of which are incorporated herein by reference.

### TECHNICAL FIELD

Embodiments of the present disclosure relate to the technical field of communications.

### BACKGROUND

In NR (new radio), for a beam failure detection procedure, a plurality of beams and beam management are supported. A MAC (Media Access Control) entity may be configured by RRC (Radio Resource Control) with a beam failure recovery procedure for each serving cell, this procedure is used to indicate a new SSB (Synchronization Signal Block) or CSI-RS (Channel Status Information Reference Signal) to a serving gNB when beam failure is detected on serving SSB(s)/CSI-RS(s). Beam failure is detected by calculating the number of beam failure instance indications from a lower layer to the MAC entity.

FIG. 1a to FIG. 1c are schematic diagrams of detection of beam failure or of a triggering process of beam failure recovery of a serving cell.

As shown in FIG. 1a, a Beam Failure Detection (BFD) procedure uses a UE variable BFI_COUNTER, this variable is a counter for a beam failure instance indication, its initial value is set to be 0, and each serving cell is configured with a counter.

For each serving cell configured for beam failure detection, the MAC entity shall:
if a beam failure instance indication has been received from lower layers:
   start or restart beamFailureDetectionTimer;
   increment BFI_COUNTER by 1;
   if BFI_COUNTER is greater than or equal to beamFailureInstanceMaxCount:
      if the serving cell is a secondary cell (SCell), trigger a BFR (beam failure recovery) for this serving cell;
      else, initiate a random access procedure on the special cell (SpCell).

As shown in FIG. 1b and FIG. 1c, the MAC entity will further:
if beamFailureDetectionTimer expires; or
if beamFailureDetectionTimer, beamFailureInstanceMaxCount or any reference signal used for beam failure detection is reconfigured by high layers for the serving cell,
   set BFI_COUNTER to 0.

This procedure is applicable to special cells and secondary cells of Rel-15 and Rel-16.

Moreover, in the NR, for a beam failure recovery procedure, for each serving cell, RRC may configure the beam failure recovery procedure for a MAC entity, this procedure is used to indicate a new SSB or CSI-RS to a serving gNB when beam failure is detected on serving SSB(s)/CSI-RS(s).

When a MAC PDU (protocol data unit) is transmitted and the MAC PDU contains a BFR MAC CE (control element) or a truncated BFR MAC CE which contains beam failure information of a secondary cell, all BFRs triggered for the secondary cell shall be cancelled. The MAC entity will:
if the beam failure recovery procedure determines that at least one BFR has been triggered, and not cancelled:
   if UL-SCH (uplink shared channel) resources are available for a new transmission and the UL-SCH resources can accommodate a BFR MAC CE plus its subheader as a result of LCP (logical channel prioritization), instruct a multiplexing and assembly procedure to generate the BFR MAC CE;
   else if UL-SCH resources are available for a new transmission and the UL-SCH resources can accommodate a truncated BFR MAC CE plus its subheader as a result of LCP, instruct a multiplexing and assembly procedure to generate the truncated BFR MAC CE;
else, trigger a SR (scheduling request) for secondary cell beam failure recovery for each secondary cell for which the BFR has been triggered and not cancelled.

It should be noted that the above introduction to the technical background is just to facilitate a clear and complete description of the technical solutions of the present disclosure, and is elaborated to facilitate the understanding of persons skilled in the art. It cannot be considered that said technical solutions are known by persons skilled in the art just because these solutions are elaborated in the Background of the present disclosure.

### SUMMARY

The inventor finds that in a procedure or processing related to beam failure recovery, the related art (BFR/SR cancellation) only considers carrying beam failure recovery information of a secondary cell via a legacy BFR MAC CE, i.e. a BFR MAC CE or a truncated BFR MAC CE, and does not consider carrying beam failure recovery information of a secondary cell via an enhanced BFR MAC CE, i.e. an enhanced BFR MAC CE or a truncated enhanced BFR MAC CE. As a result, a terminal cannot correctly and timely restart beam failure detection, or cancel a triggered BFR or a pending SR, or stop an on-going random access procedure, thereby air interface overhead increases, power consumption of the terminal and network increases, and even a service interruption is caused, and user experience is reduced.

For the above problem, the embodiments of the present disclosure provide a method and an apparatus for beam failure recovery of a secondary cell, so as to avoid the waste of air interface resources caused by transmission of BFR information of the secondary cell for many times, and the energy consumption of a terminal and a network.

According to an aspect of the embodiments of the present disclosure, an apparatus for beam failure recovery of a secondary cell is provided, the apparatus including:
a transmitting unit configured to transmit a first MAC CE containing beam failure information of the secondary cell, the first MAC CE including a MAC CE containing BFD-RS set information, the MAC CE containing BFD-RS set information including at least one of the following: an enhanced BFR MAC CE, and a truncated enhanced BFR MAC CE; and
a processing unit configured to, when the first MAC CE containing beam failure information of the secondary cell is transmitted or is successfully transmitted, enable a MAC entity of a terminal equipment to perform one of the following or a combination thereof:
cancelling all triggered BFRs of the secondary cell;
resetting a beam failure instance counter (BFI_COUNTER);
considering a beam failure recovery procedure completed successfully;
cancelling a pending SR and stopping a corresponding scheduling request prohibit timer (sr-ProhibitTimer); and
stopping an on-going corresponding random access procedure.

One of advantageous effects of the embodiments of the present disclosure lies in: according to the embodiments of the present disclosure, unnecessary triggering of BFR of a secondary cell or its SR, or the waste of air interface resources caused by transmission of BFR information of the secondary cell for many times, the energy consumption of a terminal and a network, and service interruption caused by an unnecessary random access procedure can be avoided, so as to ensure user experience.

According to another aspect of the embodiments of the present disclosure, an apparatus for beam failure recovery of a secondary cell is provided, the apparatus including:
a processing unit configured to, when a highest ServCellIndex of a secondary cell of a MAC entity of a terminal equipment for which a beam failure is detected in at least one BFD-RS set and candidate beam evaluation has been completed is less than 8, and a highest ServCellIndex of a secondary cell of the MAC entity for which a beam failure is detected and candidate beam evaluation has been completed is less than 8, enable the MAC entity to use a first MAC CE with a single-byte Ci bitmap, otherwise, the processing unit enables the MAC entity to use a first MAC CE with a 4-byte Ci bitmap.

According to a further aspect of the embodiments of the present disclosure, an apparatus for beam failure recovery of a secondary cell is provided, the apparatus including:
a processing unit configured to, when a ServCellIndex of at least one secondary cell of a MAC entity of a terminal equipment for which a beam failure is detected in at least one BFD-RS set and candidate beam evaluation has been completed is greater than 8, or a ServCellIndex of at least one secondary cell of the MAC entity for which a beam failure is detected and candidate beam evaluation has been completed is greater than 8, enable the MAC entity to use an enhanced BFR MAC CE with a 4-byte Ci bitmap, otherwise, the processing unit enables the MAC entity to use an enhanced BFR MAC CE with a single-byte Ci bitmap.

One of advantageous effects of the embodiments of the present disclosure lies in: according to the embodiments of the present disclosure, in a case where a highest ServCellIndex of a secondary cell configured with two BFD-RS sets for which a beam failure is detected in at least one BFD-RS set and candidate beam evaluation has been completed is less than 8, a terminal is capable of providing a network with beam failure information and beam failure recovery information of the secondary cell not configured with (two) BFD-RS sets and with a ServCellIndex being greater than 8, so that the secondary cell not configured with (two) BFD-RS sets can use a beam with good quality, thereby ensuring a peak rate of a user, avoiding service interruption and improving the user experience.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the spirit and terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

FIG. 1a to FIG. 1c are schematic diagrams of detection of beam failure or of a triggering process of beam failure recovery of a serving cell;

FIG. 2 is a schematic diagram of carrying BFR information of a secondary cell by using a legacy BFR MAC CE;

FIG. 3 is a schematic diagram of carrying BFR information of a secondary cell by using an enhanced BFR MAC CE;

FIG. 4 is a schematic diagram of a BFR MAC CE and a truncated BFR MAC CE, having a single-byte Ci field;

FIG. 5 is a schematic diagram of a BFR MAC CE and a truncated BFR MAC CE, having a 4-byte Ci field;

FIG. 6 is a schematic diagram of an enhanced BFR MAC CE and a truncated enhanced BFR MAC CE, having a single-byte Ci field;

FIG. 7 is a schematic diagram of an enhanced BFR MAC CE and a truncated enhanced BFR MAC CE, having a 4-byte Ci field;

FIG. 8 is a schematic diagram of a method for beam failure recovery of a secondary cell in the embodiments of the present disclosure;

FIG. 9 is another schematic diagram of a method for beam failure recovery of a secondary cell in the embodiments of the present disclosure;

FIG. 10 is a schematic diagram of an apparatus for beam failure recovery of a secondary cell in the embodiments of the present disclosure;

FIG. 11 is another schematic diagram of an apparatus for beam failure recovery of a secondary cell in the embodiments of the present disclosure;

FIG. 12 is a schematic diagram of a terminal equipment in the embodiments of the present disclosure.

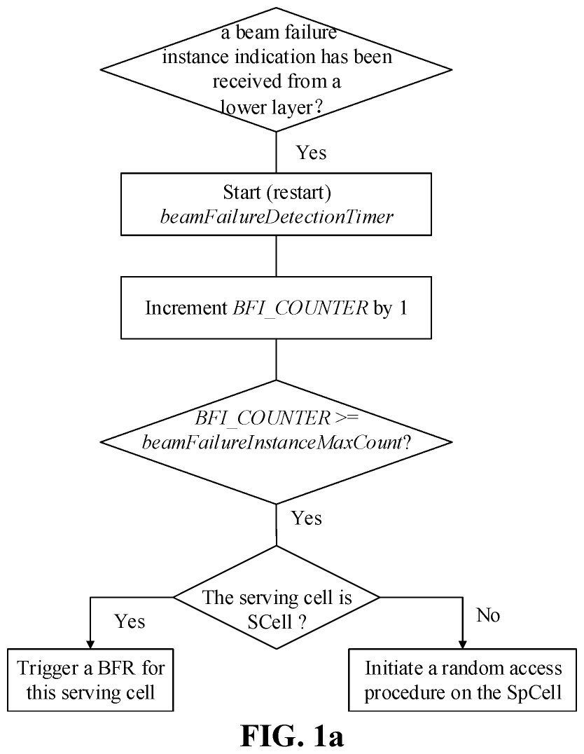

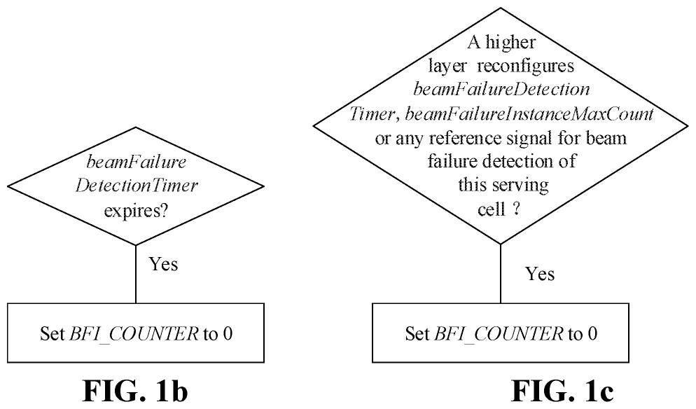

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system can be carried out according to a communication protocol at any stage, for example may include but be not limited to the following communication protocols: 1G (generation), 2G, 2.5G, 2.75G, 3G, 4G, 4.5G, 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: node B (NodeB or NB), evolution node B (eNodeB or eNB) and a 5G base station (gNB), etc., and may further includes Remote Radio Head (RRH), Remote Radio Unit (RRU), a relay or a low power node (such as femeto, pico, etc.), Integrated Access and Backhaul (IAB) node or IAB-DU or IAB-donor. And the term “base station” may include some or all functions of a base station, each base station may provide communication coverage to a specific geographic region. The term “a cell” may refer to a base station and/or its coverage area, which depends on the context in which this term is used. Where there is no confusion, the terms “cell” and “base station” are interchangeable.

In the embodiments of the present disclosure, the term “User Equipment (UE)” or “Terminal Equipment (TE) or Terminal Device” refers to, for example, a device that accesses a communication network and receives network services through a network device. The terminal equipment can be fixed or mobile, and can also be referred to as Mobile Station (MS), a terminal, Subscriber Station (SS), Access Terminal (AT), IAB-MT, a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipments as described above. If it is not specifically mentioned herein, “a device” may refer to a network device, or may refer to a terminal equipment.

In the following description, without causing confusion, “if . . . ”, “in a case where . . . ” and “when . . . ” may be used interchangeably.

The inventor finds that in Rel-15 and Rel-16, cell-level beam failure detection is supported; under the R17 multi-TRP operation, beam failure detection for a per-TRP separate BFD-RS (Beam Failure Detection Reference Signal) set is supported, and synchronous configuration of cell-specific BFR and TRP-specific BFR on different CCs (Component Carriers) is supported, but synchronous configuration of TRP-specific BFR and Rel-15/16 BFR (i.e., BeamFailureRecoveryConfig/BeamFailureRecoverySCellConfig-r16) on same CC is not supported.

According to the agreement reached at the last RAN 2 (Radio Access Network Working Group 2) meeting, a legacy BFR MAC CE and an enhanced BFR MAC CE are not triggered at the same time. If at least one cell is configured with two BFD-RS sets, the enhanced BFR MAC CE is used for BFR of a servicing cell configured with or without a BFD-RS set.

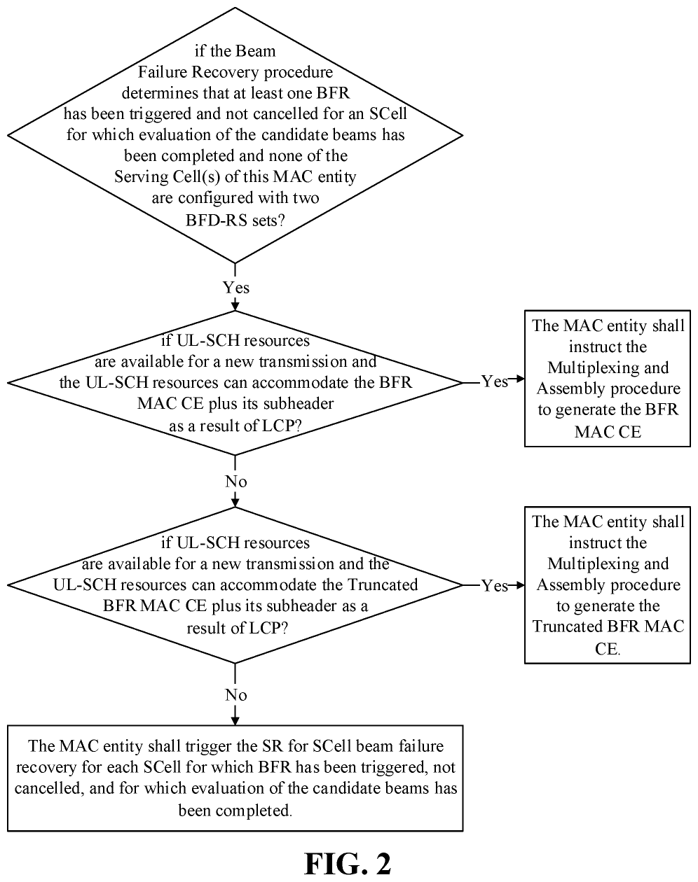

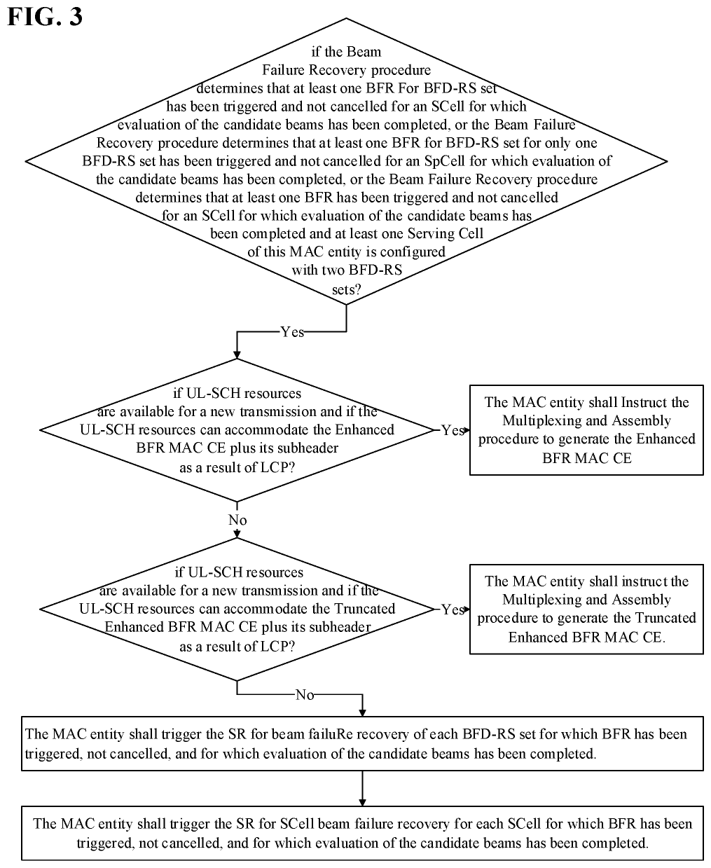

According to the above agreement, a BFR procedure described in a current protocol is shown in FIGS. 2 and 3.

As shown in FIG. 2, a MAC entity will:
1> if a beam failure recovery procedure determines that at least one BFR has been triggered and not canceled for a secondary cell (an SCell) for which evaluation of the candidate beams has been completed and none of the serving cell(s) of this MAC entity are configured with two BFD-RS sets:
   2> if a UL-SCH resource is available for a new transmission and the UL-SCH resource can accommodate a BFR MAC CE plus its subheader as a result of LCP:
      3> instruct a multiplexing and assembly procedure to generate the BFR MAC CE.
   2> else if a UL-SCH resource is available for a new transmission and the UL-SCH resource can accommodate a truncated BFR MAC CE plus its subheader as a result of LCP:
      3> instruct a multiplexing and assembly procedure to generate the truncated BFR MAC CE.
   2> otherwise:
      3> trigger an SR for secondary cell beam failure recovery for each secondary cell for which BFR has been triggered, not cancelled, and for which evaluation of the candidate beams has been completed.

Moreover, as shown in FIG. 3, a MAC entity will:
1> if a beam failure recovery procedure determines that at least one BFR for BFD-RS set has been triggered and not cancelled for a secondary cell (an SCell) for which evaluation of the candidate beams has been completed; or
1> if a beam failure recovery procedure determines that at least one BFR for BFD-RS set for only one BFD-RS set has been triggered and not cancelled for a special cell (an SpCell) for which evaluation of the candidate beam has been completed; or
1> if a beam failure recovery procedure determines that at least one BFR has been triggered and not cancelled for a secondary cell (SCell) for which evaluation of the candidate beams has been completed at least one serving cell of the MAC entity is configured with two BFD-RS sets:
   2> if a UL-SCH resource is available for a new transmission and if the UL-SCH resource can accommodate an enhanced BFR MAC CE plus its subheader as a result of LCP:
      3> instruct a multiplexing and assembly procedure to generate the enhanced BFR MAC CE.
   2> otherwise, if a UL-SCH resource is available for a new transmission and if the UL-SCH resource can accommodate a truncated enhanced BFR MAC CE plus its subheader as a result of LCP:
      3> instruct a multiplexing and assembly procedure to generate the truncated enhanced BFR MAC CE.
   2> otherwise:
      3> trigger an SR for beam failure recovery of each BFD-RS set for which BFR has been triggered, not cancelled, and for which evaluation of the candidate beam has been completed;
      3> trigger an SR for secondary cell beam failure recovery for each secondary cell for which BFR has been triggered, not cancelled, and for which evaluation of the candidate beams has been completed.

In addition, in the Standard, for a 2-step random access procedure, the following behaviors are specified:

For each MSGA (message A), the MAC entity will:
1> if this is a first MSGA transmission in this random access procedure:
   2> if this transmission is not performed for a CCCH (Common Control Channel) logical channel:
      3> instruct a multiplexing and assembly entity to include a C-RNTI (Cell Radio Network Temporary Identifier) MAC CE in a subsequent uplink transmission.
   2> if this random access procedure is initiated for special cell beam failure recovery and spCell-BFR-CBRA is configured with a value “true”:
      3> if at least one serving cell of this MAC entity is configured with two BFD-RS sets:
         4> instruct a multiplexing and assembly entity to include an enhanced BFR MAC CE or a truncated enhanced BFR MAC CE in a subsequent uplink transmission.
      3> otherwise:
         4> instruct a multiplexing and assembly entity to include a BFR MAC CE or a truncated BFR MAC CE in a subsequent uplink transmission.
   2> if this random access procedure is initiated for beam failure recovery for two BFD-RS sets for a special cell:
      3> instruct a multiplexing and assembly entity to include an enhanced BFR MAC CE or a truncated enhanced BFR MAC CE in a subsequent uplink transmission.
   2> according to HARQ (Hybrid Automatic Retransmission Request) information determined for a MSGA payload, obtain a to-be-transmitted MAC PDU from a multiplexing and assembly entity and store the same in MSGA buffer.

In addition, in the Standard, a 4-step random access procedure adopts similar steps to the 2-step random access procedure.

In the embodiments of the present disclosure, a terminal is configured with carrier aggregation, some serving cells are configured with beam failure detection, some of these serving cells are configured with two BFD-RS sets, that is, beam failure detection for the BFD-RS sets is performed, and some cells are not configured with two BFD-RS sets, that is, beam failure detection for serving cells is performed. Beam failure recovery for this secondary cell is triggered when a terminal detects a beam failure for this serving cell.

For example, a terminal is configured with at least two serving cells to perform carrier aggregation, cell 1 (a special cell) is configured with beam failure detection and is configured with two BFD-RS sets; cell 2 (a secondary cell) is configured with beam failure detection and is not configured with two BFD-RS sets. The terminal performs beam failure detection for a BFD-RS set for each BFD-RS set of cell 1, and performs beam failure detection for a serving cell for cell 2. The above text is just illustrated by examples, the terminal may further be configured with other cells, such as cell 3.

In the above scenarios, when the terminal triggers secondary cell beam failure recovery for cell 2, a method and apparatus for beam failure recovery of a secondary cell in the embodiments of the present disclosure is applied.

The following text describes the BFR MAC CE and the enhanced BFR MAC CE involved in the embodiments of the present disclosure.

MAC CEs of BFR include a BFR MAC CE or a truncated BFR MAC CE. The BFR MAC CE and the truncated BFR MAC CE are identified by a MAC subheader with LCID/eLCID.

The BFR MAC CE and the truncated BFR MAC CE have a variable size. They include a bitmap and in ascending order based on ServCellIndex, beam failure recovery information i.e., octets containing candidate beam availability indication (AC) for a secondary cell indicated in the bitmap.

For the BFR MAC CE, when a highest serving cell index ServCellIndex of by a MAC entity's secondary cell for which a beam failure is detected and candidate beam evaluation has been completed is less than 8, a single-byte bitmap is used; otherwise, 4-byte bitmap is used. One MAC PDU shall contain at most one BFR MAC CEt.

For the truncated BFR MAC CE, if a highest serving cell index ServCellIndex of a secondary cell in which a beam failure is detected by this MAC entity and candidate beam evaluation has been completed is less than 8, or a beam failure is detected for a special cell and the special cell will be indicated in a truncated BFR MAC CE and a result of LCP is that UL-SCH resources cannot accommodate a truncated BFR MAC CE plus its subheader of a 4-byte bitmap, a single-byte bitmap is used; otherwise, 4-byte bitmap is used.

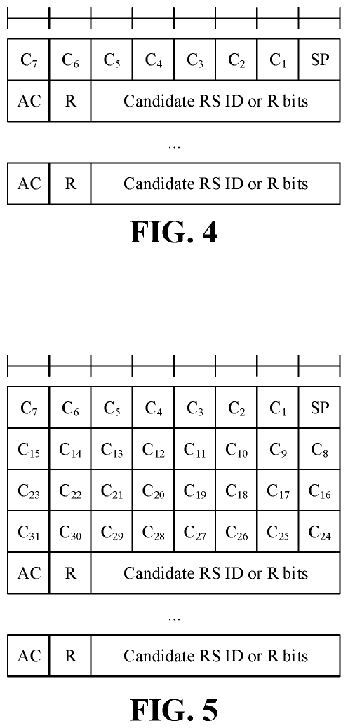

FIG. 4 is a schematic diagram of a BFR MAC CE and a truncated BFR MAC CE, having a single-byte Ci field, FIG. 5 is a schematic diagram of a BFR MAC CE and a truncated BFR MAC CE, having a 4-byte Ci field, and as shown in FIGS. 4 and 5, fields in MAC CEs of BFR are defined as follows:
SP: this field indicates beam failure detection for a special cell of this MAC entity. Only when a BFR MAC CE or a truncated BFR MAC CE will be included in a MAC PDU as a part of a random access procedure, an SP field is set to be 1 to indicate a beam failure of the special cell, otherwise, it is set to be 0;
Ci (BFR MAC CE): this field indicates beam failure detection for a secondary cell with ServCellIndex i, and the presence of a byte including its AC field. A Ci field set to be 1 indicates that a beam failure is detected for a secondary cell with ServCellIndex i, candidate beam evaluation has been completed, and a byte including its AC field is present. A Ci field set to be 0 indicates that a beam failure is not detected for a secondary cell with ServCellIndex i or a beam failure is detected but candidate beam evaluation is not completed, and a byte including its AC field is not present. The byte including the AC field is present based on an ascending order of ServCellIndex;
Ci (truncated BFR MAC CE): this field indicates beam failure detection for a secondary cell with ServCellIndex i. A Ci field set to be 1 indicates that a beam failure is detected for a secondary cell with ServCellIndex i, candidate beam evaluation has been completed, and a byte including its AC field might be present. A Ci field set to be 0 indicates that a beam failure is not detected for a secondary cell with ServCellIndex i or a beam failure is detected but candidate beam evaluation is not completed, and a byte including its AC field is not present. If present, the byte including the AC field appears based on an ascending order of ServCellIndex. The number of included bytes including the AC field (may be 0) is maximized, and does not exceed an available grant size at the same time.
AC: this field indicates the presence of a candidate RS ID field in this byte. If this AC field is set to be 1, the candidate RS ID field exists. If this AC field is set to be 0, R bits exist.
Candidate RS ID: this field is set as an index of an SSB or a CSI-RS. A length of this field is 6 bits.
R: a reserved bit, set to be 0.

In addition, enhanced MAC CEs of BFR include an enhanced BFR MAC CE or a truncated enhanced BFR MAC CE.

The enhanced BFR MAC CE and the truncated enhanced BFR MAC CE include an SP field, a Ci bitmap (signal byte or 4 bytes), a Sj bitmap (0 to 4 bytes), beam failure recovery information of BFD-RS sets of a special cell configured with two BFD-RS sets, i.e., include bytes for candidate beam availability indication (AC), and beam failure recovery information of BFD-RS sets of a secondary cell indicated in a Ci bitmap based on an ascending order of ServCellIndex, i.e., include bytes for availability indication (AC) of candidate beams. For the enhanced BFR MAC CE, when a highest ServCellIndex of a secondary cell of this MAC entity for which a beam failure is detected in at least one BFD-RS set and candidate beam evaluation has been completed is less than 8, a single-byte Ci bitmap is used; otherwise, 4-byte Ci bitmap is used.

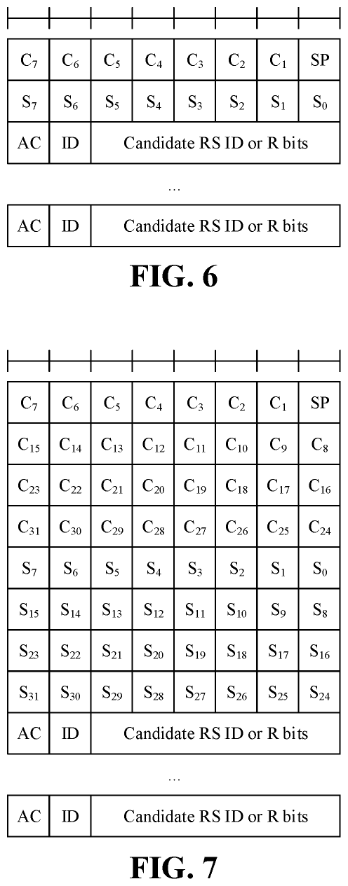

FIG. 6 is a schematic diagram of an enhanced BFR MAC CE and a truncated enhanced BFR MAC CE, having a single-byte Ci field, FIG. 7 is a schematic diagram of an enhanced BFR MAC CE and a truncated enhanced BFR MAC CE, having a 4-byte Ci field, and as shown in FIGS. 6 and 7, fields in MAC CEs of enhanced BFR are defined as follows:
SP (enhanced BFR MAC CE): this field indicates beam failure detection for a special cell of this MAC entity, and the presence of byte including an AC field, if the special cell is configured with a plurality of BFD-RS sets. For a special cell configured with two BFD-RS sets, this field set to be 1 indicates that beam failure is detected in at least one BFD-RS set, evaluation of candidate beams has been completed, and the byte including the AC field for the special cell exist; otherwise, it is set to be 0. Byte including the AC field of the special cell are included before a secondary cell. For a special cell not configured with a plurality of BFD-RS sets, the SP field set to be 1 indicates that a beam failure is detected for the special cell; otherwise, it is set to be 0;
SP (truncated enhanced BFR MAC CE): this field indicates beam failure detection for a special cell of this MAC entity. For a special cell configured with two BFD-RS sets, this field set to be 1 indicates that beam failure is detected in at least one BFD-RS set, evaluation of candidate beams has been completed, and the byte including the AC field of the special cell might exist; otherwise, it is set to be 0. Byte including the AC field of the special cell are included before a secondary cell. For a special cell not configured with a plurality of BFD-RS sets, the SP field set to be 1 indicates that a beam failure is detected for the special cell; otherwise, it is set to be 0;
Ci (enhanced BFR MAC CE): this field indicates beam failure detection for a secondary cell with ServCellIndex i, and the presence of byte including an AC field. The Ci field set to be 1 indicates that for a secondary cell with ServCellIndex being i, beam failure is detected in at least one BFD-RS set, evaluation of candidate beams has been completed, and the byte including the AC field exist; this Ci field set to be 0 indicates that for a secondary cell with ServCellIndex being i, beam failure is not detected for neither BFD-RS set or beam failure is detected in at least one BFD-RS set but evaluation of candidate beams has not been completed yet, and the byte including the AC field do not exist. Byte including the AC field exist based on an ascending order of ServCellIndex, if any, are included after byte including the AC field of the special cell;
Ci (truncated enhanced BFR MAC CE): this field indicates beam failure detection for a secondary cell with ServCellIndex i. The Ci field set to be 1 indicates that for a secondary cell with ServCellIndex being i, beam failure is detected in at least one BFD-RS set, evaluation of candidate beams has been completed, and the byte including the AC field might exist; this Ci field set to be 0 indicates that for a secondary cell with ServCellIndex being i, beam failure is not detected for neither BFD-RS set or beam failure is detected in at least one BFD-RS set but evaluation of candidate beams has not been completed yet, and the byte including the AC field do not exist;
Sₖ (enhanced BFR MAC CE): this field corresponds to a K^{th} serving cell in which a SP/Ci field is set to be 1 and two BFD-RS sets are configured. A serving cell in which the SP/Ci field is set to be 1 and two BFD-RS sets are configured starts from a special cell, and then is indexed in a sequence of secondary cells based on an ascending order of ServCellIndex i. This field indicates whether beam failure is detected for one or two BFD-RSes, and the presence of one or two byte including a AC field of a serving cell. The Sk field set to be 1 indicates that two BFD-RS sets of this serving cell have detected a beam failure, two BFD-RS sets have completed candidate beam evaluation, and byte including the AC field of two BFD-RS sets exist. The Sk field set to be 0 indicates that one BFD-RS set of this serving cell has detected a beam failure and has completed candidate beam evaluation, or two BFD-RS sets have detected a beam failure but candidate beam evaluation of two BFD-RS sets has not been completed yet, and byte including the AC field of only one BFD-RS set of this serving cell exist. A Sk field not mapped to any serving cell is set to be 0;
Sₖ (truncated enhanced BFR MAC CE): this field corresponds to a K^{th} serving cell in which the SP/Ci field is set to be 1 and two BFD-RS sets are configured. A serving cell in which the SP/Ci field is set to be 1 and two BFD-RS sets are configured starts from a special cell, and then is indexed in a sequence of secondary cells based on an ascending order of ServCellIndex i. This field indicates whether beam failure is detected for one or two BFD-RSes, and the presence of one or two bytes including the AC field of a serving cell. The Sₖ field set to be 1 indicates that beam failure is detected for two BFD-RS sets of this serving cell, candidate beam evaluation has been completed for two BFD-RS sets, and byte including the AC field of zero, one or two BFD-RS sets of this serving cell exist. The Sₖ field set to be 0 indicates that beam failure is detected for one BFD-RS set of this serving cell and candidate beam evaluation has been completed, or beam failure is detected for two BFD-RS sets but candidate beam evaluation for two BFD-RS sets has not been completed yet, or byte including the AC field of only zero or one BFD-RS set of this serving cell exist. A Sₖ field not mapped to any serving cell is set to be 0;
AC: this field indicates the presence of a candidate RS ID in this byte. If SSBs whose at least one SS-RSRP is higher than rsrp-ThresholdBFR in SSBs in a candidate beam list (i.e., candidateBeamRSSCellList of a secondary cell not configured with two BFD-RS sets, candidateBeamresourceList or candidateBeamresourceList2 of a serving cell configured with two BFD-RS sets), or CSI-RSs whose at least one CSI-RSRP is higher than rsrp-ThresholdBFR in CSI-RSs in a candidate beam list are available, the AC field is set to be 1; otherwise, it is set to be 0. If this AC field is set to be 1, the candidate RS ID field exists. If this AC field is set to be 0, R bit substitutes it to exist;
ID: this field indicates an identify of a BFD-RS set. If this byte corresponds to BFD-RS set 0, it is set to be 0. If this byte corresponds to BFD-RS set 1, it is set to be 1. For a serving cell not configured with two BFD-RS sets, this field is set to be 0;
Candidate RS ID: this field is set to be an index of an SSB whose SS-RSRP is higher than rsrp-ThresholdBFR in SSBs in a candidate beam list (i.e., candidate BeamRSSCellList of a secondary cell not configured with two BFD-RS sets, candidate BeamresourceList or candidate BeamresourceList2 of a serving cell configured with two BFD-RS sets), or an index of a CSI-RS whose CSI-RSRP is higher than rsrp-ThresholdBFR in CSI-RSs in a candidate beam list. The index of the SSB or CSI-RS is an index of an entry corresponding to this SSB or CSI-RS in the candidate beam list. Index 0 corresponds to the first entry in the candidate beam list, index 1 corresponds to the second entry in the list, and so on in a similar fashion. A length of this field is 6 bits;
R: a reserved bit, set to be 0.

The embodiments of the present disclosure are described below in conjunction with the drawings and the specific implementations.

### Embodiments of a First Aspect

Embodiments of the present disclosure provide a method for beam failure recovery of a secondary cell.

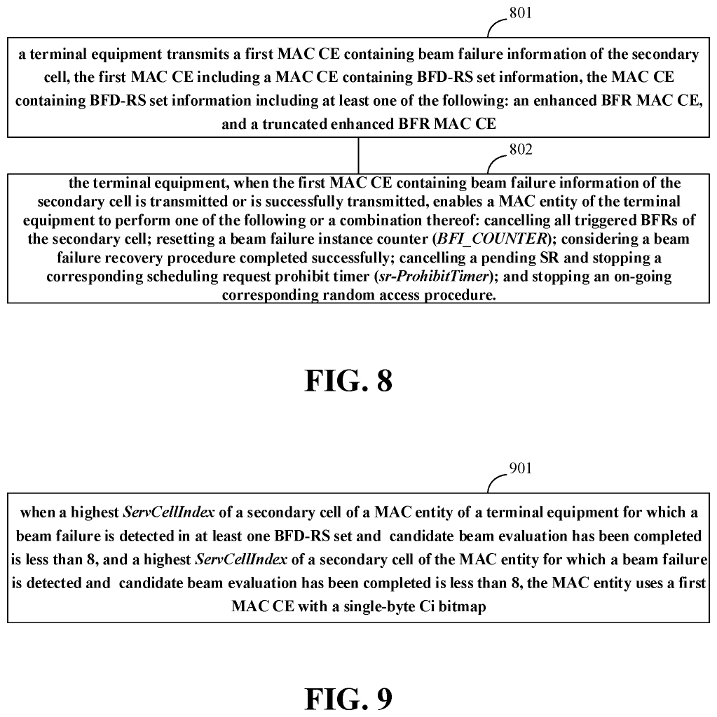

FIG. 8 is a schematic diagram of a method for beam failure recovery of a secondary cell in the embodiments of the present disclosure. As shown in FIG. 8, the method includes:
801, a terminal equipment transmits a first MAC CE containing beam failure information of the secondary cell, the first MAC CE including a MAC CE containing BFD-RS set information, the MAC CE containing BFD-RS set information including at least one of the following: an enhanced BFR MAC CE, and a truncated enhanced BFR MAC CE; and
802, the terminal equipment, when the first MAC CE containing beam failure information of the secondary cell is transmitted or is successfully transmitted, enables a MAC entity of the terminal equipment to perform one of the following or a combination thereof:
cancelling all triggered BFRs of the secondary cell;
resetting a beam failure instance counter (BFI_COUNTER);
considering a beam failure recovery procedure completed successfully;
cancelling a pending SR and stopping a corresponding scheduling request prohibit timer (sr-ProhibitTimer); and
stopping an on-going corresponding random access procedure.

According to the embodiments of the present disclosure, when a first MAC CE containing beam failure information of a secondary cell is transmitted or successfully transmitted, the first MAC CE includes a MAC CE containing BFD-RS set information, such as an enhanced BFR MAC CE or a truncated enhanced BFR MAC CE, a MAC entity cancels all triggered BFRs of the secondary cell, or resets BFI_COUNTER, or considers a beam failure recovery procedure completed successfully, or cancels a s pending SR and stopping corresponding sr-ProhibitTimer, or stops an on-going corresponding random access procedure, etc., which avoids waste of air interface resource, power consumption of a terminal and a network, caused by unnecessary triggering of BFRs of the secondary cell or its SR or by transmission of BFR information of the secondary cell for many times, as well as service interruption caused by an unnecessary random access procedure, thereby to ensure user experience.

It should be noted that the above FIG. 8 only schematically describes the embodiments of the present disclosure, but the present disclosure is not limited to this. For example, other some operations can be added or operations therein may be reduced. Persons skilled in the art may make appropriate modifications according to the above contents, not limited to the records in the above FIG. 8.

In some embodiments, the first MAC CE may further carry beam failure information and beam failure recovery information of a BFD-RS set of a serving cell.

In the embodiments of the present disclosure, in some scenarios, the terminal equipment is configured with carrier aggregation, and some serving cells in serving cells performing carrier aggregation are configured with beam failure detection.

In the above embodiments, one or more serving cells in serving cells configured with beam failure detection is/are configured with two BFD-RS sets, thereby beam failure detection for a BFD-RS set may be performed. Moreover, one or more serving cells in serving cells configured with beam failure detection is/are not configured with a BFD-RS set, thereby beam failure detection for the serving cell(s) may be performed.

In some embodiments, the secondary cell is a serving cell configured with beam failure detection but not configured with a BFD-RS set.

In some embodiments, the first MAC CE is contained in a MAC PDU, that is, when a MAC PDU is transmitted or successfully transmitted, and the MAC PDU contains the first MAC CE, the MAC entity performs one or a combination of the preceding processings.

In the embodiments of the present disclosure, the first MAC CE may further include a MAC CE not containing BFD-RS set information, the MAC CE not containing BFD-RS set information e.g. including at least one of the following: a BFR MAC CE, and a truncated BFR MAC CE. The MAC CE not containing BFD-RS set information is used to implement its related functions, description is omitted here.

In some embodiments, when the first MAC CE containing beam failure information of the secondary cell is transmitted, a MAC entity of the terminal equipment cancels all triggered BFRs of the secondary cell. For example, when a MAC PDU is transmitted and the MAC PDU contains the first MAC CE, the MAC entity cancels all triggered BFRs of the secondary cell.

In a related art, when a MAC PDU is transmitted and the PDU includes a BFR MAC CE or a truncated BFR MAC CE that contains beam failure information of a secondary cell, all triggered BFRs of the secondary cell will be cancelled.

However, if a terminal is configured with carrier aggregation of a plurality of serving cells, cell 1 is configured with two BFD-RS sets, and secondary cell 2 is not configured with a BFD-RS set, and according to the agreement of the current RAN 2, when BFR is triggered on the cell 2, a MAC entity might indicate to generate an enhanced BFR MAC CE or a truncated enhanced BFR MAC CE, so as to include BFR information of the secondary cell 2. However, according to the related art, even if a MAC PDU containing this enhanced BFR MAC CE or truncated enhanced BFR MAC CE is transmitted, the MAC entity will not cancel BFRs triggered by the secondary cell 2. That is, the MAC entity might continue to indicate to generate an enhanced BFR MAC CE or a truncated enhanced BFR MAC CE, so as to include BFR information of the secondary cell 2, which has already been transmitted. This will result in a waste of resources and increase energy consumption of terminals and networks.

In the above embodiments, when a MAC PDU is transmitted and the MAC PDU contains the enhanced BFR MAC CE or the truncated enhanced BFR MAC CE containing the beam failure information of the secondary cell, the MAC entity cancels all triggered BFRs of the secondary cell.

In the above embodiments, when a MAC PDU is transmitted and the MAC PDU contains the BFR MAC CE or the truncated BFR MAC CE containing the beam failure information of the secondary cell, the MAC entity cancels all triggered BFRs of the secondary cell.

According to the above embodiments, when a MAC PDU containing an enhanced BFR MAC CE or a truncated enhanced BFR MAC CE containing beam failure recovery information is transmitted, the MAC entity will cancel triggered BFRs of the secondary cell. Thereby, waste of air interface resources caused by transmission of BFR information of the secondary cell for many times, and the energy consumption of a terminal and a network are avoided.

In some embodiments, when the first MAC CE containing beam failure information of the secondary cell is successfully transmitted, a MAC entity of the terminal equipment cancels all triggered BFRs of the secondary cell. For example, if the terminal equipment receives a PDCCH (Physical Downlink Control Channel) addressed by a C-RNTI and the PDCCH indicates an uplink grant for a new transmission for a first HARQ process, the MAC entity cancels all triggered BFRs of the secondary cell. The first HARQ process transmits the first MAC CE containing the beam failure recovery information of the secondary cell.

In the related art, for each serving cell configured with beam failure detection, if this serving cell is not configured with two BFD-RS sets, if this serving cell is a secondary cell, a PDCCH addressed by the C-RNTI is received and the PDCCH indicates an uplink grant for a new transmission for a HARQ process used for transmission of the BFR MAC CE or the truncated BFR MAC CE containing the beam failure recovery information of this serving cell, the MAC entity will set BFI_COUNTER to be 0, considers a beam failure recovery procedure completed successfully, and cancels all triggered BFRs of this serving cell.

However, as described above, if a terminal is configured with carrier aggregation of a plurality of serving cells, cell 1 is configured with two BFD-RS sets, and secondary cell 2 is not configured with a BFD-RS set, and according to the agreement of the current RAN 2, when BFR is triggered on the cell 2, a MAC entity might indicate to generate an enhanced BFR MAC CE or a truncated enhanced BFR MAC CE, so as to include BFR information of the secondary cell 2. However, according to the related art, even if a MAC PDU containing this enhanced BFR MAC CE or truncated enhanced BFR MAC CE is transmitted, the MAC entity will not cancel triggered BFRs of the secondary cell 2. That is, the MAC entity might continue to indicate to generate an enhanced BFR MAC CE or a truncated enhanced BFR MAC CE, so as to include BFR information of the secondary cell 2, which has already been transmitted. This will result in a waste of resources and increase energy consumption of terminals and networks.

In the above embodiments, for each serving cell configured with beam failure detection, if the serving cell is not configured with two BFD-RS sets, if the serving cell is a secondary cell, the terminal equipment receives the PDCCH addressed by the C-RNTI and the PDCCH indicates an uplink grant for a new transmission for a HARQ process used for transmission of the enhanced BFR MAC CE or the truncated enhanced BFR MAC CE containing the beam failure recovery information of the serving cell, the MAC entity cancels all triggered BFRs of the serving cell.

In the above embodiments, if the PDCCH indicates an uplink grant for a new transmission for a HARQ process used for transmission of the BFR MAC CE or the truncated BFR MAC CE containing the beam failure recovery information of the serving cell, the MAC entity also cancels all triggered BFRs of the serving cell.

According to the above embodiments, when a MAC PDU containing an enhanced BFR MAC CE or a truncated enhanced BFR MAC CE containing beam failure recovery information is successfully transmitted, the MAC entity will cancel triggered BFRs of the secondary cell. Thereby, waste of air interface resources caused by transmission of BFR information of the secondary cell for many times, and the energy consumption of a terminal and a network are avoided.

In some embodiments, when the first MAC CE containing beam failure information of a secondary cell is successfully transmitted, a MAC entity of a terminal equipment resets a beam failure instance counter. For example, if the terminal equipment receives a PDCCH addressed by a C-RNTI and the PDCCH indicates an uplink grant for a new transmission for a first HARQ process, the MAC entity sets the beam failure instance counter to be 0. The first HARQ process transmits the first MAC CE containing the beam failure recovery information of the secondary cell.

In the above embodiments, that the first MAC CE containing the beam failure information of the secondary cell is successfully transmitted includes that a MAC PDU is successfully transmitted, the MAC PDU containing the first MAC CE containing the beam failure information of the secondary cell.

In the related art, for each serving cell configured with beam failure detection, if this serving cell is not configured with two BFD-RS sets, if this serving cell is a secondary cell, a PDCCH addressed by the C-RNTI is received and the PDCCH indicates an uplink grant for a new transmission for a HARQ process used for transmission of the BFR MAC CE or the truncated BFR MAC CE containing the beam failure recovery information of this serving cell, the MAC entity will set BFI_COUNTER to be 0, considers a beam failure recovery procedure completed successfully, and cancels all triggered BFRs of this serving cell.

However, if a terminal is configured with carrier aggregation of a plurality of serving cells, cell 1 is configured with two BFD-RS sets, and secondary cell 2 is not configured with a BFD-RS set, and according to the agreement of the current RAN 2, when BFR is triggered on the cell 2, a MAC entity might indicate to generate an enhanced BFR MAC CE or a truncated enhanced BFR MAC CE, so as to include BFR information of the secondary cell 2. However, according to the related art, even if a MAC PDU containing this enhanced BFR MAC CE or truncated enhanced BFR MAC CE is transmitted, the MAC entity will not reset a beam failure instance counter of the secondary cell. That is, the MAC entity will continue to calculate beam failure instances received from a lower layer, and trigger BFRs again. This will result in a waste of resources, increasing of energy consumption of terminals and networks, even cause service interruption and reducing of user experience.

In the above embodiments, for each serving cell configured with beam failure detection, if the serving cell is not configured with two BFD-RS sets, if the serving cell is a secondary cell, the terminal equipment receives the PDCCH addressed by the C-RNTI and the PDCCH indicates an uplink grant for a new transmission for a HARQ process used for transmission of the enhanced BFR MAC CE or the truncated enhanced BFR MAC CE containing the beam failure recovery information of the serving cell, the MAC entity sets the beam failure instance counter to be 0.

In the above embodiments, if the PDCCH indicates an uplink grant for a new transmission for a HARQ process used for transmission of the BFR MAC CE or the truncated BFR MAC CE containing the beam failure recovery information of the serving cell, the MAC entity also sets the beam failure instance counter to be 0.

According to the above embodiments, when a MAC PDU containing an enhanced BFR MAC CE or a truncated enhanced BFR MAC CE containing beam failure recovery information is successfully transmitted, the MAC entity will reset the beam failure instance counter. Thereby, triggering of unnecessary BFRs of a secondary cell, and waste of air resources and energy consumption of terminals and networks resulted therefrom are avoided.

In some embodiments, when the first MAC CE containing beam failure information of the secondary cell is transmitted, a MAC entity of the terminal equipment cancels a pending SR and stops a corresponding scheduling request prohibit timer. For example, if a MAC PDU is transmitted and the MAC PDU contains the first MAC CE, the MAC entity cancels the pending SR, and if the corresponding scheduling request prohibit timer is running, the MAC entity stops the corresponding scheduling request prohibit timer.

In the related art, when an SR is triggered, it is considered as been pended until it is cancelled. For each pending SR not triggered by a serving cell according to a BFR procedure, if the SR is triggered by beam failure recovery of a secondary cell, and a MAC PDU is transmitted and the PDU includes a BFR MAC CE or a truncated BFR MAC CE containing beam failure information of the secondary cell, the MAC entity will cancel the pending SR and stop a corresponding sr-ProhibitTimer (if it is running).

However, if a terminal is configured with carrier aggregation of a plurality of serving cells, cell 1 is configured with two BFD-RS sets, and secondary cell 2 is not configured with a BFD-RS set, when BFR is triggered on the cell 2, the MAC entity might trigger an SR request resource of SCell BFR. According to the agreement of the current RAN 2, when there is an available uplink resource, the MAC entity might indicate to generate an enhanced BFR MAC CE or a truncated enhanced BFR MAC CE, so as to include BFR information of the secondary cell 2. However, according to the related art, even if a MAC PDU containing this enhanced BFR MAC CE or truncated enhanced BFR MAC CE is transmitted, the MAC entity will not cancel a pending SR. That is, the MAC entity will continue to transmit an SR to a network, so as to request an uplink resource. This will result in a waste of resources and increase energy consumption of terminals and networks.

In the above embodiments, for each pending SR of a serving cell not triggered according to a BSR (Buffer Status Report) procedure, if an SR is triggered by the beam failure recovery of the secondary cell, a MAC PDU is transmitted and the MAC PDU contains the enhanced BFR MAC CE or the truncated enhanced BFR MAC CE containing the beam failure recovery information of the secondary cell, the MAC entity cancels the pending SR, and if a corresponding scheduling request prohibit timer is running, the MAC entity stops the corresponding scheduling request prohibit timer.

In the above embodiments, if the MAC PDU contains a BFR MAC CE or a truncated BFR MAC CE containing beam failure information of the secondary cell, the MAC entity also cancels the pending SR and stops a corresponding sr-ProhibitTimer (if it is running).

According to the above embodiments, when a MAC PDU containing an enhanced BFR MAC CE or a truncated enhanced BFR MAC CE containing beam failure recovery information is transmitted, the MAC entity will cancel the pending SR. Thereby, triggering of an unnecessary SR of BFRs of a secondary cell, and waste of air resources and energy consumption of terminals and networks resulted therefrom are avoided.

In some embodiments, when the first MAC CE containing beam failure information of the secondary cell is transmitted, a MAC entity of the terminal equipment stops an on-going corresponding random access procedure. For example, if the terminal equipment transmits a MAC PDU and the MAC PDU contains the first MAC CE, the MAC entity stops the corresponding random access procedure.

In the above embodiments, the corresponding random access procedure refers to a random access procedure caused by a pending SR of a BFR of the secondary cell configured with a valid PUCCH (Physical Uplink Control Channel) resource. However, the present disclosure is not limited to this. In addition, the random access procedure may be carried out on a special cell of a cell group in which the secondary cell is located, but the present disclosure is not limited to this.

In the related art, if a MAC PDU is transmitted by using an uplink grant other than an uplink grant provided by an RAR (Random Access Response) or an UL (uplink) grant determined by transmission of a MSGA payload, and the PDU includes a BFR MAC CE or a truncated BFR MAC CE containing beam failure information of a secondary cell; or the secondary cell is deactivated and all triggered BFRs of the secondary cell are cancelled, the MAC entity may stop an ongoing random access procedure of BFR of the secondary cell, caused by a pending SR configured with no valid PUCCH resource.

However, if a terminal is configured with carrier aggregation of a plurality of serving cells, cell 1 is configured with two BFD-RS groups, and secondary cell 2 is not configured with a BFD-RS set, when BFR is triggered on the cell 2, the MAC entity may trigger an SR of SCell BFR, and initiate a random access procedure in a case where a valid PUCCH resource is not configured. According to the agreement of the previous RAN 2, when there is an available uplink resource, the MAC entity might indicate to generate an enhanced BFR MAC CE or a truncated enhanced BFR MAC CE, so as to include BFR information of the secondary cell 2. However, according to the related art, even if a MAC PDU containing the enhanced BFR MAC CE or the truncated enhanced BFR MAC CE is transmitted by using an uplink grant other than an uplink grant provided by the RAR or an UL grant determined by transmission of a MSGA payload, the MAC entity will not stop an ongoing random access procedure. This will result in service interruption and reduce user experience.

In the above embodiments, if a terminal equipment transmits a MAC PDU by using an uplink grant other than an uplink grant provided by the RAR and an UL grant determined by transmission of a MSGA payload, and the MAC PDU contains the enhanced BFR MAC CE or the truncated enhanced BFR MAC CE containing the beam failure recovery information of the secondary cell, the MAC entity stops a corresponding random access procedure.

In the above embodiments, if the MAC PDU contains a BFR MAC CE or a truncated BFR MAC CE containing the beam failure information of the secondary cell, the MAC entity also stops a corresponding random access procedure.

According to the above embodiments, an uplink grant other than an uplink grant provided by the RAR or an UL grant determined by transmission of a MSGA payload is used to transmit a MAC PDU containing the enhanced BFR MAC CE or the truncated enhanced BFR MAC CE containing beam failure recovery information of the secondary cell, the MAC entity may stop an ongoing corresponding random access procedure. Thereby, service interruption caused by a random access procedure is avoided, and user experience is ensured.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the method in the above embodiments, unnecessary triggering of BFR of a secondary cell or its SR, or the waste of air interface resources and the energy consumption of a terminal and a network caused by transmission of BFR information of the secondary cell for many times, and service interruption caused by an unnecessary random access procedure can be avoided, so as to ensure user experience.

In addition, according to the related art, when a highest ServCellIndex of a secondary cell of a MAC entity for which a beam failure is detected in at least one BFD-RS set and candidate beam evaluation has been completed is less than 8, an enhanced BFR MAC CE with a single-byte Ci bitmap is used; otherwise, an enhanced BFR MAC CE with 4-byte Ci bitmap is used.

However, in a case of reporting a secondary cell failure via the enhanced BFR MAC CE, if a highest ServCellIndex of a secondary cell for which a beam failure is detected in at least one BFD-RS set and candidate beam evaluation has been completed is less than 8, even if an enhanced BFR MAC CE with a single-byte Ci bitmap is used, this enhanced BFR MAC CE cannot indicate a beam failure situation of a secondary cell with ServCellIndex being greater than 8 and not configured with a BFD-RS set, a network may consider that a beam failure is not detected in these secondary cells. This will cause the secondary cells to fail to work, thereby reducing a peak rate of users, and resulting in service interruption or poor user experience.

In addition, the truncated enhanced BFR MAC CE also has a similar problem.

FIG. 9 is another schematic diagram of a method for beam failure recovery of a secondary cell in the embodiments of the present disclosure, as shown in FIG. 9, the method includes:
901: when a highest ServCellIndex of a secondary cell of a MAC entity of a terminal equipment for which a beam failure is detected in at least one BFD-RS set and candidate beam evaluation has been completed is less than 8, and a highest ServCellIndex of a secondary cell of the MAC entity for which a beam failure is detected and candidate beam evaluation has been completed is less than 8, the MAC entity uses a first MAC CE with a single-byte Ci bitmap.

In some embodiments, the first MAC CE includes a MAC CE containing BFD-RS set information, the MAC CE containing BFD-RS set information including at least one of the following: an enhanced BFR MAC CE, and a truncated enhanced BFR MAC CE. Definition of the MAC CE containing BFD-RS set information has been described in the preceding text, and is not repeated here.

For example, when a highest ServCellIndex of a secondary cell of a MAC entity for which a beam failure is detected in at least one BFD-RS set and candidate beam evaluation has been completed is less than 8, and a highest ServCellIndex of a secondary cell of the MAC entity for which a beam failure is detected and candidate beam evaluation has been completed is less than 8, the MAC entity uses an enhanced BFR MAC CE with a single-byte Ci bitmap, otherwise, the MAC entity uses an enhanced BFR MAC CE with a 4-byte Ci bitmap.

For another example, when at least one of the following situations is met, the MAC entity uses a truncated enhanced BFR MAC CE with a single-byte Ci bitmap, otherwise, uses a truncated enhanced BFR MAC CE with a 4-byte Ci bitmap:
the highest ServCellIndex of the secondary cell of a MAC entity for which a beam failure is detected in at least one BFD-RS set and candidate beam evaluation has been completed is less than 8, and the highest ServCellIndex of the secondary cell of the MAC entity for which a beam failure is detected and candidate beam evaluation has been completed is less than 8;
a beam failure is detected for a special cell not configured with two BFD-RS sets, the special cell is to be indicated in a truncated enhanced BFR MAC CE, and as a result of LCP, UL-SCH resources available for transmission cannot accommodate a truncated enhanced BFR MAC CE with a 4-byte Ci bitmap plus its subheader; and
a random access procedure is initiated for beam failure recovery of both BFD-RS sets of a special cell configured with the two BFD-RS sets and the special cell is to be indicated in a truncated enhanced BFR MAC CE, and as a result of LCP, UL-SCH resources available for transmission cannot accommodate a truncated enhanced BFR MAC CE with a 4-byte Ci bitmap plus its subheader.

In the above embodiments, for the enhanced BFR MAC CE, when a highest ServCellIndex of a secondary cell of a MAC entity for which a beam failure is detected in at least one BFD-RS set and candidate beam evaluation has been completed is less than 8, and a highest ServCellIndex of a secondary cell of the MAC entity for which a beam failure is detected and candidate beam evaluation has been completed is less than 8, an enhanced BFR MAC CE with a single-byte Ci bitmap is used, otherwise, an enhanced BFR MAC CE with a 4-byte Ci bitmap is used. Or, when a ServCellIndex of at least one secondary cell of a MAC entity for which a beam failure is detected in at least one BFD-RS set and candidate beam evaluation has been completed is greater than 8, or a ServCellIndex of at least one secondary cell of a MAC entity for which a beam failure is detected and candidate beam evaluation has been completed is greater than 8, the MAC entity uses an enhanced BFR MAC CE with a 4-byte Ci bitmap, otherwise, the MAC entity uses an enhanced BFR MAC CE with a single-byte Ci bitmap.

In the above embodiments, for the truncated enhanced BFR MAC CE, in the following situations, the MAC entity uses a truncated enhanced BFR MAC CE with a single-byte Ci bitmap, otherwise, uses a truncated enhanced BFR MAC CE with a 4-byte Ci bitmap:
the highest ServCellIndex of the secondary cell of the MAC entity for which a beam failure is detected in at least one BFD-RS set and candidate beam evaluation has been completed is less than 8, and the highest ServCellIndex of the secondary cell of the MAC entity for which a beam failure is detected and candidate beam evaluation has been completed is less than 8; or,
a beam failure is detected for a special cell not configured with two BFD-RS sets, the special cell is to be indicated in a truncated enhanced BFR MAC CE, and as a result of LCP, UL-SCH resources available for transmission cannot accommodate a truncated enhanced BFR MAC CE with a 4-byte Ci bitmap plus its subheader; or,
a random access procedure is initiated for beam failure recovery of both BFD-RS sets of a special cell configured with the two BFD-RS sets and the special cell is to be indicated in a truncated enhanced BFR MAC CE, and as a result of LCP, UL-SCH resources available for transmission cannot accommodate a truncated enhanced BFR MAC CE with a 4-byte Ci bitmap plus its subheader.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the method in the above embodiments, in a case where a highest ServCellIndex of a secondary cell configured with two BFD-RS sets for which a beam failure is detected in at least one BFD-RS set and candidate beam evaluation has been completed is less than 8, a terminal is capable of providing a network with beam failure information and beam failure recovery information of the secondary cell not configured with (two) BFD-RS sets and with a ServCellIndex being greater than 8, so that the secondary cell not configured with (two) BFD-RS sets can use a beam with good quality, thereby ensuring a peak rate of a user, avoiding service interruption and improving the user experience.

### Embodiments of a Second Aspect

Embodiments of the present disclosure provide an apparatus for beam failure recovery of a secondary cell. The apparatus may, for example, be a terminal equipment, or may be one or more parts or components configured in the terminal equipment. The apparatus in the embodiments of the present disclosure corresponds to the method in the embodiments of the first aspect, the contents same as those in the embodiments of the first aspect are not repeated.

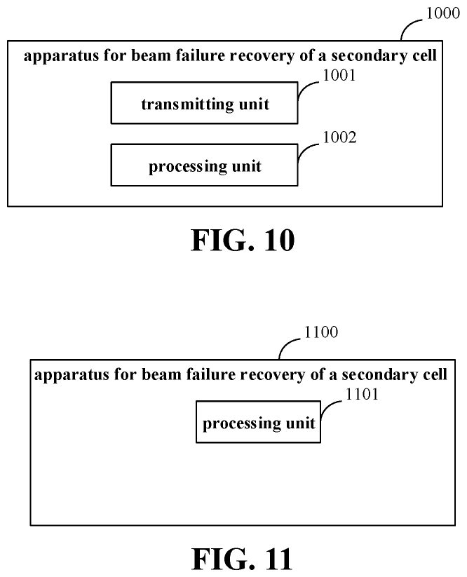

FIG. 10 is a schematic diagram of an example of an apparatus for beam failure recovery of a secondary cell in the embodiments of the present disclosure. As shown in FIG. 10, an apparatus 1000 for beam failure recovery of a secondary cell includes:
a transmitting unit 1001 configured to transmit a first MAC CE containing beam failure information of the secondary cell, the first MAC CE including a MAC CE containing BFD-RS set information, the MAC CE containing BFD-RS set information including at least one of the following: an enhanced BFR MAC CE, and a truncated enhanced BFR MAC CE; and
a processing unit 1002 configured to, when the first MAC CE containing beam failure information of the secondary cell is transmitted or is successfully transmitted, enable a MAC entity of a terminal equipment to perform one of the following or a combination thereof:
cancelling all triggered BFRs of the secondary cell;
resetting a beam failure instance counter (BFI_COUNTER);
considering a beam failure recovery procedure completed successfully;
cancelling a pending SR and stopping a corresponding scheduling request prohibit timer (sr-ProhibitTimer); and
stopping an on-going corresponding random access procedure.

In some embodiments, a terminal equipment is configured with carrier aggregation, and some serving cells in serving cells performing carrier aggregation are configured with beam failure detection.

One or more serving cells in the serving cells configured with beam failure detection are configured with two BFD-RS sets; and/or one or more serving cells in the serving cells configured with beam failure detection are not configured with a BFD-RS set.

In some embodiments, the first MAC CE is contained in a MAC PDU. For example, that the transmitting unit 1001 transmits the first MAC CE containing beam failure information of a secondary cell includes that the transmitting unit 1001 transmits a MAC PDU containing the first MAC CE.

In some embodiments, the first MAC CE further includes a MAC CE not containing BFD-RS set information, the MAC CE not containing BFD-RS set information including at least one of the following: a BFR MAC CE, and a truncated BFR MAC CE.

In some embodiments, when the first MAC CE containing beam failure information of the secondary cell is transmitted, a MAC entity of the terminal equipment cancels all triggered BFRs of the secondary cell. For example, when a MAC PDU is transmitted and the MAC PDU contains the first MAC CE, the MAC entity cancels all triggered BFRs of the secondary cell.

In the above embodiments, when a MAC PDU is transmitted and the MAC PDU contains the enhanced BFR MAC CE or the truncated enhanced BFR MAC CE containing the beam failure information of the secondary cell, the MAC entity of the terminal equipment cancels all triggered BFRs of the secondary cell.

In some embodiments, when the first MAC CE containing beam failure information of the secondary cell is successfully transmitted, the MAC entity of the terminal equipment cancels all triggered BFRs of the secondary cell. For example, if the terminal equipment receives a PDCCH addressed by a C-RNTI and the PDCCH indicates an uplink grant for a new transmission for a first HARQ process, the MAC entity cancels all triggered BFRs of the secondary cell; wherein, the first HARQ process transmits the first MAC CE containing beam failure recovery information of the secondary cell.

In the above embodiments, for each serving cell configured with beam failure detection, if the serving cell is not configured with two BFD-RS sets, if the serving cell is a secondary cell, the terminal equipment receives the PDCCH addressed by the C-RNTI and the PDCCH indicates an uplink grant for a new transmission for a HARQ process used for transmission of the enhanced BFR MAC CE or the truncated enhanced BFR MAC CE containing the beam failure recovery information of the serving cell, the MAC entity cancels all triggered BFRs of the serving cell.

In some embodiments, when the first MAC CE containing beam failure information of a secondary cell is successfully transmitted, a MAC entity of a terminal equipment resets a beam failure instance counter. For example, if the terminal equipment receives a PDCCH addressed by a C-RNTI and the PDCCH indicates an uplink grant for a new transmission for a first HARQ process, the MAC entity sets the beam failure instance counter to be 0; wherein, the first HARQ process transmits the first MAC CE containing beam failure recovery information of the secondary cell.

In the above embodiments, that the first MAC CE containing the beam failure information of the secondary cell is successfully transmitted includes that a MAC PDU is successfully transmitted, the MAC PDU containing the first MAC CE containing the beam failure information of the secondary cell.

In the above embodiments, for each serving cell configured with beam failure detection, if the serving cell is not configured with two BFD-RS sets, if the serving cell is a secondary cell, the terminal equipment receives the PDCCH addressed by the C-RNTI and the PDCCH indicates an uplink grant for a new transmission for a HARQ process used for transmission of the enhanced BFR MAC CE or the truncated enhanced BFR MAC CE containing the beam failure recovery information of the serving cell, the MAC entity sets the beam failure instance counter to be 0.

In some embodiments, when the first MAC CE containing beam failure information of the secondary cell is transmitted, a MAC entity of the terminal equipment cancels a pending SR and stops a corresponding scheduling request prohibit timer. For example, if a MAC PDU is transmitted and the MAC PDU contains the first MAC CE, the MAC entity cancels the pending SR, and if the corresponding scheduling request prohibit timer is running, the MAC entity stops the corresponding scheduling request prohibit timer.

In the above embodiments, for each pending SR of a serving cell not triggered according to a BSR procedure, if an SR is triggered by the beam failure recovery of the secondary cell, a MAC PDU is transmitted and the MAC PDU contains the enhanced BFR MAC CE or the truncated enhanced BFR MAC CE containing the beam failure recovery information of the secondary cell, the MAC entity cancels the pending SR, and if the corresponding scheduling request prohibit timer is running, the MAC entity stops the corresponding scheduling request prohibit timer.

In the embodiments of the present disclosure, the corresponding random access procedure refers to a random access procedure caused by a pending SR of a BFR of the secondary cell not configured with a valid PUCCH resource.

In some embodiments, when the first MAC CE containing beam failure information of the secondary cell is transmitted, a MAC entity of the terminal equipment stops an on-going corresponding random access procedure. For example, if the terminal equipment transmits a MAC PDU and the MAC PDU contains the first MAC CE, the MAC entity stops the corresponding random access procedure.

In the above embodiments, if the terminal equipment transmits a MAC PDU by using an uplink grant other than an uplink grant provided by the RAR and an UL grant determined by transmission of a MSGA payload, and the MAC PDU contains the enhanced BFR MAC CE or the truncated enhanced BFR MAC CE containing the beam failure recovery information of the secondary cell, the MAC entity stops the corresponding random access procedure.

The above text is only illustrative for the embodiments of the present disclosure, but the present disclosure is not limited to this, appropriate modifications can be also made based on the above each embodiment. For example, each of the above embodiments may be used individually, or one or more of the above embodiments may be combined.

According to the apparatus in the above embodiments, unnecessary triggering of BFR of a secondary cell or its SR, or the waste of air interface resources caused by transmission of BFR information of the secondary cell for many times, the energy consumption of a terminal and a network, and service interruption caused by an unnecessary random access procedure can be avoided, so as to ensure user experience.

FIG. 11 is a schematic diagram of another example of an apparatus for beam failure recovery of a secondary cell in the embodiments of the present disclosure. As shown in FIG. 11, an apparatus 1100 for beam failure recovery of a secondary cell includes:
a processing unit 1101 configured to, when a highest ServCellIndex of a secondary cell of a MAC entity of a terminal equipment for which a beam failure is detected in at least one BFD-RS set and candidate beam evaluation has been completed is less than 8, and a highest ServCellIndex of a secondary cell of the MAC entity for which a beam failure is detected and candidate beam evaluation has been completed is less than 8, enable the MAC entity to use a first MAC CE with a single-byte Ci bitmap.

In some embodiments, when a ServCellIndex of at least one secondary cell of a MAC entity of a terminal equipment for which a beam failure is detected in at least one BFD-RS set and candidate beam evaluation has been completed is greater than 8, or a ServCellIndex of at least one secondary cell of the MAC entity for which a beam failure is detected and candidate beam evaluation has been completed is greater than 8, the processing unit 1101 enables the MAC entity to use an enhanced BFR MAC CE with a 4-byte Ci bitmap, otherwise, the processing unit 1101 enables the MAC entity to use an enhanced BFR MAC CE with a single-byte Ci bitmap.

In some embodiments, the first MAC CE includes a MAC CE containing BFD-RS set information, the MAC CE containing BFD-RS set information including at least one of the following: an enhanced BFR MAC CE, and a truncated enhanced BFR MAC CE.

For example, when a highest ServCellIndex of a secondary cell of the MAC entity for which a beam failure is detected in at least one BFD-RS set and candidate beam evaluation has been completed is less than 8, and a highest ServCellIndex of a secondary cell of the MAC entity for which a beam failure is detected and candidate beam evaluation has been completed is less than 8, the MAC entity uses an enhanced BFR MAC CE with a single-byte Ci bitmap, otherwise, the MAC entity uses an enhanced BFR MAC CE with a 4-byte Ci bitmap.

For another example, when at least one of the following situations is met, the MAC entity uses a truncated enhanced BFR MAC CE with a single-byte Ci bitmap, otherwise, uses a truncated enhanced BFR MAC CE with a 4-byte Ci bitmap:
the highest ServCellIndex of the secondary cell of the MAC entity for which a beam failure is detected in at least one BFD-RS set and candidate beam evaluation has been completed is less than 8, and the highest ServCellIndex of the secondary cell of the MAC entity for which a beam failure is detected and candidate beam evaluation has been completed is less than 8;
a beam failure is detected for a special cell not configured with two BFD-RS sets, the special cell is to be indicated in a truncated enhanced BFR MAC CE, and as a result of LCP, UL-SCH resources available for transmission cannot accommodate a truncated enhanced BFR MAC CE with a 4-byte Ci bitmap plus its subheader; and
a random access procedure is initiated for beam failure recovery of both BFD-RS sets of a special cell configured with the two BFD-RS sets and the special cell is to be indicated in a truncated enhanced BFR MAC CE, and as a result of LCP, UL-SCH resources available for transmission cannot accommodate a truncated enhanced BFR MAC CE with a 4-byte Ci bitmap plus its subheader.

The above text is only illustrative for the embodiments of the present disclosure, but the present disclosure is not limited to this, appropriate modifications can be also made based on the above each embodiment. For example, each of the above embodiments may be used individually, or one or more of the above embodiments may be combined.

According to the apparatus in the above embodiments, in a case where a highest ServCellIndex of a secondary cell configured with two BFD-RS sets for which a beam failure is detected in at least one BFD-RS set and candidate beam evaluation has been completed is less than 8, a terminal is capable of providing a network with beam failure information and beam failure recovery information of the secondary cell not configured with (two) BFD-RS sets and with a ServCellIndex being greater than 8, so that the secondary cell not configured with (two) BFD-RS sets can use a beam with good quality, thereby ensuring a peak rate of a user, avoiding service interruption and improving the user experience.

It's worth noting that the above only describes components or modules related to the present disclosure, but the present disclosure is not limited to this. Apparatuses 1000, 1100 for beam failure recovery of a secondary cell may further include other components or modules. For detailed contents of these components or modules, relevant technologies may be referred to. Moreover, the above components or modules may be realized by a hardware facility such as a processor, a memory, a transmitter, a receiver, etc. The embodiments of the present disclosure have no limitation to this.

### Embodiments of a Third Aspect

The embodiments of the present disclosure further provide a communication system, including a network device and a terminal equipment.

In some embodiments, the terminal equipment includes the apparatus described in the embodiments of the second aspect, and is configured to perform the method described in the embodiments of the first aspect. Since each method has been described in details in the embodiments of the first aspect, its contents are incorporated here and are not repeated.

The embodiments of the present disclosure further provide a terminal equipment, the terminal equipment for example may be a UE, but the present disclosure is not limited to this, it may also be other terminal equipment.

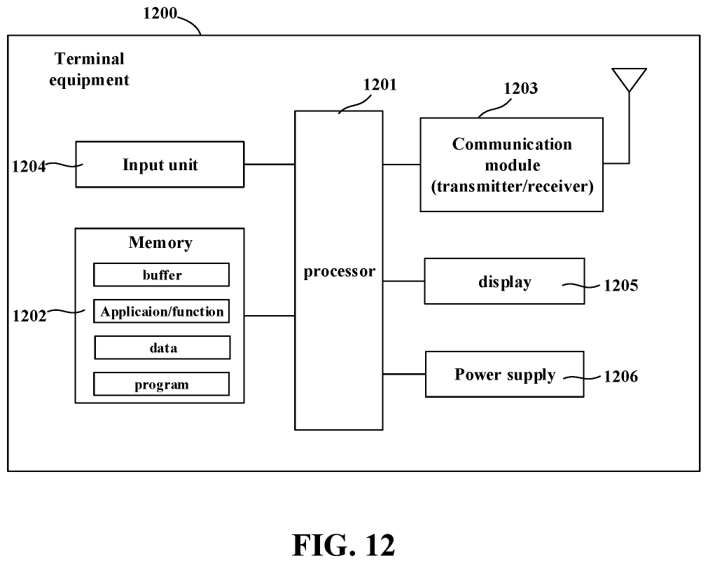

FIG. 12 is a schematic diagram of a terminal equipment in the embodiments of the present disclosure. As shown in FIG. 12, the terminal equipment 1200 may include a processor 1201 and a memory 1202; the memory 1202 stores data and programs, and is coupled to the processor 1201. It's worth noting that this figure is exemplary; other types of structures may also be used to supplement or replace this structure, so as to realize a telecommunication function or other functions.

In some embodiments, functions of the apparatus in the embodiments of the second aspect may be integrated into the processor 1201, wherein the processor 1201 may be configured to execute a program to implement the method as described in the embodiments of the first aspect, the contents of which are incorporated herein and are not described repeatedly here.

In some other embodiments, the apparatus in the embodiments of the second aspect may be configured separately from the processor 1201, for example the apparatus in the embodiments of the second aspect may be configured as a chip connected to the processor 1201, functions of the apparatus in the embodiments of the second aspect are realized through the control of the processor 1201.

As shown in FIG. 12, the terminal equipment 1200 may further include: a communication module 1203, an input unit 1204, a display 1205 and a power supply 1206. The functions of said components are similar to related arts, which are not repeated here. It's worth noting that the terminal equipment 1200 does not have to include all the components shown in FIG. 12, said components are not indispensable. Moreover, the terminal equipment 1200 may also include components not shown in FIG. 12, relevant technologies can be referred to.

The embodiments of the present disclosure further provide a computer program, wherein when a terminal equipment executes the program, the program enables the terminal equipment to execute the method described in the embodiments of the first aspect.

The embodiments of the present disclosure further provide a storage medium in which a computer program is stored, wherein the computer program enables a terminal equipment to execute the method described in the embodiments of the first aspect.

The apparatus and method in the present disclosure may be realized by hardware, or may be realized by combining hardware with software. The present disclosure relates to such a computer readable program, when the program is executed by a logic component, the computer readable program enables the logic component to realize the apparatus described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/apparatus described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the spirit and principle of the present disclosure, these variations and modifications are also within the scope of the present disclosure.

As for the implementations including the above embodiments, the following supplements are further disclosed:

1. A method for beam failure recovery of a secondary cell, wherein, the method includes:
a terminal equipment transmits a first MAC CE containing beam failure information of the secondary cell, the first MAC CE including a MAC CE containing BFD-RS set information, the MAC CE containing BFD-RS set information including at least one of the following: an enhanced BFR MAC CE, and a truncated enhanced BFR MAC CE; and
the terminal equipment, when the first MAC CE containing beam failure information of the secondary cell is transmitted or is successfully transmitted, enables a MAC entity of a terminal equipment to perform one of the following or a combination thereof:
cancelling all triggered BFRs of the secondary cell;
resetting a beam failure instance counter (BFI_COUNTER);
considering a beam failure recovery procedure completed successfully;
cancelling a pending SR and stopping a corresponding scheduling request prohibit timer (sr-ProhibitTimer); and
stopping an on-going corresponding random access procedure.

2. The method according to Supplement 1, wherein,
the terminal equipment is configured with carrier aggregation, and some serving cells in serving cells performing carrier aggregation are configured with beam failure detection.

3. The method according to Supplement 2, wherein,
one or more serving cells in the serving cells configured with beam failure detection are configured with two BFD-RS sets; and/or
one or more serving cells in the serving cells configured with beam failure detection are not configured with a BFD-RS set.

4. The method according to Supplement 1, wherein,
the first MAC CE is contained in a MAC PDU.

5. The method according to Supplement 1, wherein,
the first MAC CE further includes a MAC CE not containing BFD-RS set information, the MAC CE not containing BFD-RS set information including at least one of the following: a BFR MAC CE, and a truncated BFR MAC CE.

6. The method according to any one of Supplements 1 to 5, wherein, that when the first MAC CE containing beam failure information of the secondary cell is transmitted, a MAC entity of the terminal equipment cancels all triggered BFRs of the secondary cell, includes that:
when a MAC PDU is transmitted and the MAC PDU contains the first MAC CE, the MAC entity cancels all triggered BFRs of the secondary cell.

7. The method according to Supplement 6, wherein,
when a MAC PDU is transmitted and the MAC PDU contains the enhanced BFR MAC CE or the truncated enhanced BFR MAC CE containing the beam failure information of the secondary cell, the MAC entity of the terminal equipment cancels all triggered BFRs of the secondary cell.

8. The method according to any one of Supplements 1 to 5, wherein, that when the first MAC CE containing beam failure information of the secondary cell is successfully transmitted, a MAC entity of the terminal equipment cancels all triggered BFRs of the secondary cell, includes that:
if the terminal equipment receives a PDCCH addressed by a C-RNTI and the PDCCH indicates an uplink grant for a new transmission for a first HARQ process, the MAC entity cancels all triggered BFRs of the secondary cell;
wherein the first HARQ process transmits the first MAC CE containing the beam failure recovery information of the secondary cell.

9. The method according to Supplement 8, wherein,
for each serving cell configured with beam failure detection, if the serving cell is not configured with two BFD-RS sets, if the serving cell is a secondary cell, the terminal equipment receives the PDCCH addressed by the C-RNTI and the PDCCH indicates an uplink grant for a new transmission for a HARQ process used for transmission of the enhanced BFR MAC CE or the truncated enhanced BFR MAC CE containing the beam failure recovery information of the serving cell, the MAC entity cancels all triggered BFRs of the serving cell.

10. The method according to any one of Supplements 1 to 5, wherein, that when the first MAC CE containing beam failure information of the secondary cell is successfully transmitted, a MAC entity of the terminal equipment resets a beam failure instance counter, includes that:
if the terminal equipment receives a PDCCH addressed by a C-RNTI and the PDCCH indicates an uplink grant for a new transmission for a first HARQ process, the MAC entity sets the beam failure instance counter to be 0;
wherein the first HARQ process transmits the first MAC CE containing the beam failure recovery information of the secondary cell.

11. The method according to Supplement 10, wherein,
for each serving cell configured with beam failure detection, if the serving cell is not configured with two BFD-RS sets, if the serving cell is a secondary cell, the terminal equipment receives the PDCCH addressed by the C-RNTI and the PDCCH indicates an uplink grant for a new transmission for a HARQ process used for transmission of the enhanced BFR MAC CE or the truncated enhanced BFR MAC CE containing the beam failure recovery information of the serving cell, the MAC entity sets the beam failure instance counter to be 0.

12. The method according to any one of Supplements 1 to 5, wherein, that when the first MAC CE containing beam failure information of the secondary cell is transmitted, a MAC entity of the terminal equipment cancels a pending SR and stop a corresponding scheduling request prohibit timer, includes that:
if a MAC PDU is transmitted and the MAC PDU contains the first MAC CE, the MAC entity cancels the pending SR, and if the corresponding scheduling request prohibit timer is running, the MAC entity stops the corresponding scheduling request prohibit timer.

13. The method according to Supplement 12, wherein,
for each pending SR of a serving cell not triggered according to a BSR procedure, if an SR is triggered by the beam failure recovery of the secondary cell, a MAC PDU is transmitted and the MAC PDU contains the enhanced BFR MAC CE or the truncated enhanced BFR MAC CE containing the beam failure recovery information of the secondary cell, the MAC entity cancels the pending SR, and if the corresponding scheduling request prohibit timer is running, the MAC entity stops the corresponding scheduling request prohibit timer.

14. The method according to any one of Supplements 1 to 5, wherein, the corresponding random access procedure refers to a random access procedure caused by a pending SR of a BFR of the secondary cell not configured with a valid PUCCH resource.

15. The method according to any one of Supplements 1 to 5 and 14, wherein, that when the first MAC CE containing beam failure information of the secondary cell is transmitted, a MAC entity of the terminal equipment stops an on-going corresponding random access procedure, includes that:
if the terminal equipment transmits a MAC PDU and the MAC PDU contains the first MAC CE, the MAC entity stops the corresponding random access procedure.

16. The method according to Supplement 15, wherein,
if the terminal equipment transmits a MAC PDU by using an uplink grant other than an uplink grant provided by the RAR and an UL grant determined by transmission of a MSGA payload, and the MAC PDU contains the enhanced BFR MAC CE or the truncated enhanced BFR MAC CE containing the beam failure recovery information of the secondary cell, the MAC entity stops the corresponding random access procedure.

17. A method for beam failure recovery of a secondary cell, wherein, the method includes:
when a highest ServCellIndex of a secondary cell of a MAC entity of a terminal equipment for which a beam failure is detected in at least one BFD-RS set and candidate beam evaluation has been completed is less than 8, and a highest ServCellIndex of a secondary cell of the MAC entity for which a beam failure is detected and candidate beam evaluation has been completed is less than 8, the MAC entity uses a first MAC CE with a single-byte Ci bitmap.

18. The method according to Supplement 17, wherein,
the first MAC CE includes a MAC CE containing BFD-RS set information, the MAC CE containing BFD-RS set information including at least one of the following: an enhanced BFR MAC CE, and a truncated enhanced BFR MAC CE.

19. The method according to Supplement 17 or 18, wherein
when a highest ServCellIndex of a secondary cell of the MAC entity for which a beam failure is detected in at least one BFD-RS set and candidate beam evaluation has been completed is less than 8, and a highest ServCellIndex of a secondary cell of the MAC entity for which a beam failure is detected and candidate beam evaluation has been completed is less than 8, the MAC entity uses an enhanced BFR MAC CE with a single-byte Ci bitmap, otherwise, the MAC entity uses an enhanced BFR MAC CE with a 4-byte Ci bitmap.

20. The method according to Supplement 17 or 18, wherein
when at least one of the following situations is met, the MAC entity uses a truncated enhanced BFR MAC CE with a single-byte Ci bitmap, otherwise, uses a truncated enhanced BFR MAC CE with a 4-byte Ci bitmap:
the highest ServCellIndex of the secondary cell of the MAC entity for which a beam failure is detected in at least one BFD-RS set and candidate beam evaluation has been completed is less than 8, and the highest ServCellIndex of the secondary cell of the MAC entity for which a beam failure is detected and candidate beam evaluation has been completed is less than 8;
a beam failure is detected for a special cell not configured with two BFD-RS sets, the special cell is to be indicated in a truncated enhanced BFR MAC CE, and as a result of LCP, UL-SCH resources available for transmission cannot accommodate a truncated enhanced BFR MAC CE with a 4-byte Ci bitmap plus its subheader; and
a random access procedure is initiated for beam failure recovery of both BFD-RS sets of a special cell configured with the two BFD-RS sets and the special cell is to be indicated in a truncated enhanced BFR MAC CE, and as a result of LCP, UL-SCH resources available for transmission cannot accommodate a truncated enhanced BFR MAC CE with a 4-byte Ci bitmap plus its subheader.

21. A method for beam failure recovery of a secondary cell, wherein, the method includes:
when a ServCellIndex of at least one secondary cell of a MAC entity of a terminal equipment for which a beam failure is detected in at least one BFD-RS set and candidate beam evaluation has been completed is greater than 8, or a ServCellIndex of at least one secondary cell of the MAC entity for which a beam failure is detected and candidate beam evaluation has been completed is greater than 8, the MAC entity uses an enhanced BFR MAC CE with a 4-byte Ci bitmap, otherwise, the MAC entity uses an enhanced BFR MAC CE with a single-byte Ci bitmap.

22. A terminal equipment, including a memory and a processor, the memory storing a computer program, and the processor being configured to execute the computer program to implement the method according to any one of Supplements 1 to 21.

23. A communication system, including a network device and the terminal equipment according to Supplement 22.

What is claimed is:

1. An apparatus for beam failure recovery of a secondary cell, the apparatus comprising:
a transmitter configured to transmit a first MAC (Medium Access Control) CE (Control Element) containing beam failure information of the secondary cell, the first MAC CE including a MAC CE containing BFD (Beam Failure Detection)-RS (Reference Signal) set information, the MAC CE containing BFD-RS set information including at least one of the following: an enhanced BFR (Beam Failure Recovery) MAC CE, and a truncated enhanced BFR MAC CE; and
processor circuitry configured to, when the first MAC CE containing beam failure information of the secondary cell is transmitted or is successfully transmitted, enable a MAC entity of a terminal equipment to perform one of the following or a combination thereof:
cancelling all triggered BFRs of the secondary cell;
resetting a beam failure instance counter;
considering a beam failure recovery procedure completed successfully;
cancelling a pending SR (Scheduling Request) and stopping a corresponding scheduling request prohibit timer; and
stopping an on-going corresponding random access procedure.

2. The apparatus according to claim 1, wherein,
the terminal equipment is configured with carrier aggregation, and some serving cells in serving cells performing carrier aggregation are configured with beam failure detection.

3. The apparatus according to claim 2, wherein,
one or more serving cells in the serving cells configured with beam failure detection are configured with two BFD-RS sets; and/or
one or more serving cells in the serving cells configured with beam failure detection are not configured with a BFD-RS set.

4. The apparatus according to claim 1, wherein,
the first MAC CE is contained in a MAC PDU (Protocol Data Unit).

5. The apparatus according to claim 1, wherein,
the first MAC CE further includes a MAC CE not containing BFD-RS set information, the MAC CE not containing BFD-RS set information including at least one of the following: a BFR MAC CE, and a truncated BFR MAC CE.

6. The apparatus according to claim 1, wherein, that when the first MAC CE containing beam failure information of the secondary cell is transmitted, the processor circuitry enables a MAC entity of the terminal equipment to cancel all triggered BFRs of the secondary cell, includes that:
when a MAC PDU is transmitted and the MAC PDU contains the first MAC CE, the processor circuitry enables the MAC entity to cancel all triggered BFRs of the secondary cell.

7. The apparatus according to claim 6, wherein,
when a MAC PDU is transmitted and the MAC PDU contains the enhanced BFR MAC CE or the truncated enhanced BFR MAC CE containing the beam failure information of the secondary cell, the processor circuitry enables the MAC entity of the terminal equipment to cancel all triggered BFRs of the secondary cell.

8. The apparatus according to claim 1, wherein, that when the first MAC CE containing beam failure information of the secondary cell is successfully transmitted, the processor circuitry enables a MAC entity of the terminal equipment to cancel all triggered BFRs of the secondary cell, includes that:
if the terminal equipment receives a PDCCH (Physical Downlink Control CHannel) addressed by a C-RNTI (Cell-Radio Network Temporary Identifier) and the PDCCH indicates an uplink grant for a new transmission of a first HARQ (Hybrid Automatic Repeat reQuest) process, the processor circuitry enables the MAC entity to cancel all triggered BFRs of the secondary cell;
wherein the first HARQ process transmits the first MAC CE containing the beam failure recovery information of the secondary cell.

9. The apparatus according to claim 8, wherein,
for each serving cell configured with beam failure detection, if the serving cell is not configured with two BFD-RS sets, if the serving cell is a secondary cell, the terminal equipment receives the PDCCH addressed by the C-RNTI and the PDCCH indicates an uplink grant for a new transmission for a HARQ process used for transmission of the enhanced BFR MAC CE or the truncated enhanced BFR MAC CE containing the beam failure recovery information of the serving cell, the processor circuitry enables the MAC entity to cancel all triggered BFRs of the serving cell.

10. The apparatus according to claim 1, wherein, that when the first MAC CE containing beam failure information of the secondary cell is successfully transmitted, the processor circuitry enables a MAC entity of the terminal equipment to reset a beam failure instance counter, includes that:
if the terminal equipment receives a PDCCH addressed by a C-RNTI and the PDCCH indicates an uplink grant of a new transmission of a first HARQ process, the processor circuitry enables the MAC entity to set the beam failure instance counter to 0;
wherein the first HARQ process transmits the first MAC CE containing the beam failure recovery information of the secondary cell.

11. The apparatus according to claim 10, wherein,
for each serving cell configured with beam failure detection, if the serving cell is not configured with two BFD-RS sets, if the serving cell is a secondary cell, the terminal equipment receives the PDCCH addressed by the C-RNTI and the PDCCH indicates an uplink grant of a new transmission of a HARQ process for transmission of the enhanced BFR MAC CE or the truncated enhanced BFR MAC CE containing the beam failure recovery information of the serving cell, the processor circuitry enables the MAC entity to set the beam failure instance counter to 0.

12. The apparatus according to claim 1, wherein, that when the first MAC CE containing beam failure information of the secondary cell is transmitted, the processor circuitry enables a MAC entity of the terminal equipment to cancel a pending SR and stop a corresponding scheduling request prohibit timer, includes that:
if a MAC PDU is transmitted and the MAC PDU contains the first MAC CE, the MAC entity cancels the pending SR, and if the corresponding scheduling request prohibit timer is running, the processor circuitry enables the MAC entity to stop the corresponding scheduling request prohibit timer.

13. The apparatus according to claim 12, wherein,
for each pending SR of a serving cell that is not triggered according to a BSR procedure, if an SR is triggered by the beam failure recovery of the secondary cell, a MAC PDU is transmitted and the MAC PDU contains the enhanced BFR MAC CE or the truncated enhanced BFR MAC CE containing the beam failure recovery information of the secondary cell, the processor circuitry enables the MAC entity to cancel the pending SR, and if the corresponding scheduling request prohibit timer is running, the processor circuitry enables the MAC entity to stop the corresponding scheduling request prohibit timer.

14. The apparatus according to claim 1, wherein, that when the first MAC CE containing beam failure information of the secondary cell is transmitted, the processor circuitry enables a MAC entity of the terminal equipment to stop an on-going corresponding random access procedure, includes that:
if the terminal equipment transmits a MAC PDU and the MAC PDU contains the first MAC CE, the processor circuitry enables the MAC entity to stop the corresponding random access procedure.

15. The apparatus according to claim 14, wherein, the corresponding random access procedure refers to a random access procedure caused by a pending SR of a BFR of the secondary cell that is not configured with a valid PUCCH resource.

16. The apparatus according to claim 14, wherein,
if the terminal equipment transmits a MAC PDU by using an uplink grant other than an uplink grant provided by an RAR and a UL grant determined by transmission of an MSGA payload, and the MAC PDU contains the enhanced BFR MAC CE or the truncated enhanced BFR MAC CE containing the beam failure recovery information of the secondary cell, the processor circuitry enables the MAC entity to stop the corresponding random access procedure.

17. An apparatus for beam failure recovery of a secondary cell, the apparatus comprising:
processor circuitry configured to, when a highest ServCellIndex of a secondary cell of a MAC entity of a terminal equipment for which a beam failure is detected in at least one BFD-RS set and candidate beam evaluation has been completed is less than 8, and a highest ServCellIndex of a secondary cell of the MAC entity for which a beam failure is detected and candidate beam evaluation has been completed is less than 8, enable the MAC entity to use a first MAC CE with a single-byte Ci bitmap.

18. The apparatus according to claim 17, wherein,
the first MAC CE includes a MAC CE containing BFD-RS set information, the MAC CE containing BFD-RS set information including at least one of the following: an enhanced BFR MAC CE, and a truncated enhanced BFR MAC CE.

19. The apparatus according to claim 18, wherein,
when a highest ServCellIndex of a secondary cell of the MAC entity for which a beam failure is detected in at least one BFD-RS set and candidate beam evaluation has been completed is less than 8, and a highest ServCellIndex of a secondary cell of the MAC entity for which a beam failure is detected and candidate beam evaluation has been completed is less than 8, the processor circuitry enables the MAC entity to use an enhanced BFR MAC CE with a single-byte Ci bitmap, otherwise, the processor circuitry enables the MAC entity to use an enhanced BFR MAC CE with a 4-byte Ci bitmap.

20. The apparatus according to claim 18, wherein,
when at least one of the following situations is met, the processor circuitry enables the MAC entity to use a truncated enhanced BFR MAC CE with a single-byte Ci bitmap, otherwise, the processor circuitry enables the MAC entity to use a truncated enhanced BFR MAC CE with a 4-byte Ci bitmap:
the highest ServCellIndex of the secondary cell of the MAC entity for which a beam failure is detected in at least one BFD-RS set and candidate beam evaluation has been completed is less than 8, and the highest ServCellIndex of the secondary cell of the MAC entity for which a beam failure is detected and candidate beam evaluation has been completed is less than 8;
a beam failure is detected for a special cell not configured with two BFD-RS sets, the special cell is to be indicated in a truncated enhanced BFR MAC CE, and as a result of LCP (Logical Channel Prioritization), UL-SCH resources available for transmission cannot accommodate a truncated enhanced BFR MAC CE with a 4-byte Ci bitmap plus its subheader; and
a random access procedure is initiated for beam failure recovery of both BFD-RS sets of a special cell configured with the two BFD-RS sets and the special cell is to be indicated in a truncated enhanced BFR MAC CE, and as a result of LCP, UL-SCH resources available for transmission cannot accommodate a truncated enhanced BFR MAC CE with a 4-byte Ci bitmap plus its subheader.
